(19) United States
(12) Patent Application Publication
(10) Pub. No.: US 2011/0272091 A1
(43) Pub. Date: Nov. 10, 2011

(54) METHOD OF MANUFACTURING COMPLEX COMPOSITE PARTS

(75) Inventors: Jeff Max Buxman, Valley Center, KS (US); William Todd Ross, Cheney, KS (US); Jeremy Ryan Sanford, Maize, KS (US)

(73) Assignee: SPIRIT AEROSYSTEMS, INC., Wichita, KS (US)

(21) Appl. No.: 12/775,046

(22) Filed: May 6, 2010

(51) Int. Cl. B29C 65/00; B32B 37/00

(52) U.S. Cl. 156/285; 156/349; 156/307.1

(57) ABSTRACT

A system for manufacturing a composite part from composite material comprises a bag and a tool. The bag may retain a first portion of the composite material and may include a chamber and a sheet, to which the chamber is coupled. The chamber may be positioned adjacent a rigidized support configured to maintain the chamber in the shape of a non-planar feature of the composite part. The tool may include an upper surface configured to retain a second portion of the composite material and shaped to correspond to an outer mold line of the composite part. The bag may be placed upon the upper surface of the tool such that the composite material is fully enclosed by the combination of the bag and the upper surface of the tool. A heating element may provide a high temperature to cure the composite material.

### BACKGROUND OF THE INVENTION

1. Field of the Invention

Embodiments of the present invention relate to methods and systems for manufacturing composite parts. More particularly, embodiments of the present invention relate to methods and systems for manufacturing monolithic composite parts that utilize tooling positioned on one side of the part and a reusable flexible bag positioned on the opposite side of the part.

2. Description of the Related Art

Complex parts, such as those used in aerospace applications, are often manufactured from composite materials. Because many such parts include three-dimensional characteristics such as height, depth, curvature, contours, or features that intersect at angles up to 90 degrees, they may require extra tooling and/or handling to manufacture. For example, traditional manufacturing processes may utilize clam-shell tooling or molds, caul sheets, peel-ply sheets, or fly-away tooling. Some of these approaches may require rigid tooling for both the inner mold line and the outer mold line, which may be costly to create. Various approaches may require additional labor to peel off films or remove adhesives or residue which could increase labor costs or increase production time. Other approaches may include foam or rigid inserts to properly position or support component pieces (particularly pieces that may have a space or an opening between them) during the manufacturing process that remain within the parts after production is complete. Such extraneous inserts unnecessarily add weight to the parts. If the parts are used in a mobile system, such as an aircraft, then the additional weight may result in additional fuel consumption. The complexity of some parts may therefore be limited by the drawbacks of traditional manufacturing practices.

### SUMMARY OF THE INVENTION

Embodiments of the present invention solve the above-mentioned problems and provide a distinct advance in the art of manufacturing composite parts. More particularly, embodiments of the invention provide a system and method for manufacturing composite parts from composite material which eliminate complex and costly rigid tooling as well as inserts that remain with the parts after manufacturing is complete.

Various embodiments of the invention may provide a system for manufacturing a composite part from composite material, the system broadly comprising a bag and a tool. The bag generally retains a first portion of the composite material and may include a sheet and a chamber. The sheet may be made from continuous, flexible material. The chamber, coupled to the sheet, may include a cavity in which the first portion of composite material is held. Adjacent to the chamber may be a rigidized support member configured to maintain the pouch in the shape of a non-planar feature of the composite part.

The tool may include an upper surface configured to retain a second portion of the composite material and shaped to correspond to an outer mold line of the composite part. The bag may be placed upon the upper surface of the tool such that the first portion of composite material contacts the second portion. A heating element may provide a high temperature to cure the composite material.

Various embodiments of the invention may also provide a method of manufacturing a composite part from composite material. The method may comprise the steps of: placing a first portion of the composite material in a pouch of a bag, wherein the pouch includes a rigidized support member, placing a second portion of the composite material on an upper surface of a tool, placing the bag over the second portion of the composite material on the tool surface, applying a vacuum between the bag and the tool, and curing the composite material by exposing the material to a high temperature such that the first portion of the composite material is cocured with the second portion.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a side elevational view of a system constructed in accordance with various embodiments of the present invention for manufacturing a composite part from composite materials;

FIG. 2 is a perspective view of two components of the system—a bag and a tool;

FIG. 3 is a sectional view of the bag;

FIG. 4 is a sectional view of the bag placed on the tool;

FIG. 5 is a perspective view of the composite part seen from above;

FIG. 6 is a perspective view of the composite part seen from below; and

FIG. 7 is a flow diagram of at least a portion of the steps of a method of manufacturing a composite part from composite material.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

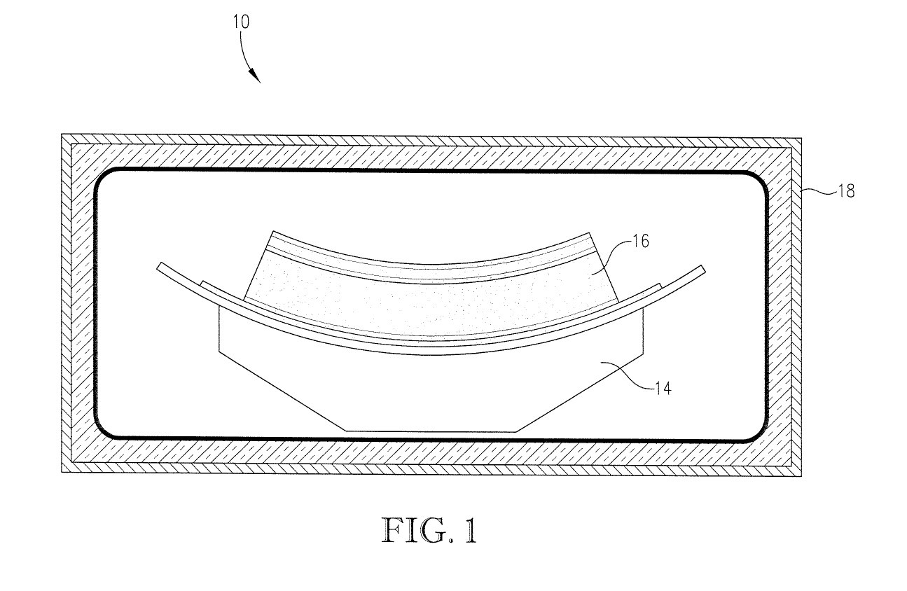

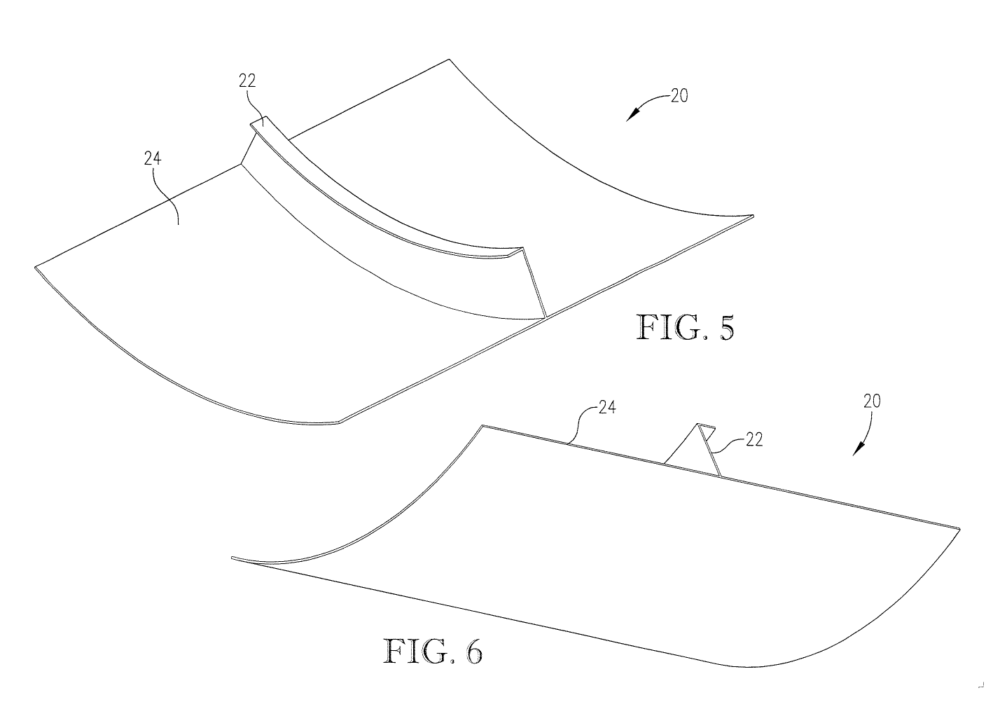

A system 10 constructed in accordance with various aspects of the current invention for manufacturing complex composite parts is shown in FIG. 1. The system 10 may broadly comprise a tool 14, a bag 16, and a heating element 18. The complex composite parts manufactured with system 10 may include three-dimensional characteristics such as height, depth, curvature, contours, features that intersect at angles up to and including ninety degrees, or features that include a space between them. Such composite parts are often utilized in the manufacturing of aircraft, wherein various sections of an airplane, such as the wing, the tail, or the fuselage, may include dozens or hundreds of component pieces. An example of a composite part 20 that may be manufactured using the system 10 and methods disclosed herein is a portion of an aircraft fuselage skin as shown in FIGS. 5 and 6.

The composite parts are typically formed from composite material, as is known in the art, which generally includes at least two constituent components—a reinforcement material and a matrix material. The reinforcement material generally provides mechanical strengthening properties, such as high tensile strength, to the composite material, while the matrix material acts as a binder to hold the reinforcement material together. The reinforcement material and the matrix material may possess additional properties not discussed herein. Furthermore, the composite material may include additional components not discussed herein.

Examples of the reinforcement material that may be used with the current invention include, but are not limited to, fiber materials such as carbon fiber, boron fiber, fiberglass, aramid fiber, ceramic fiber, and the like. In the case of fiber-based reinforcement materials, the fiber may exist in one of at least two forms—either preimpregnated (prepreg), in which the fiber may be coated with a matrix material that is uncured, such as uncured resin, or as dry fiber, with no matrix material incorporated prior to part manufacture. The matrix material may typically be in the form of polymer resins, such as epoxies, bismaleimides, vinyl esters, and the like, among others.

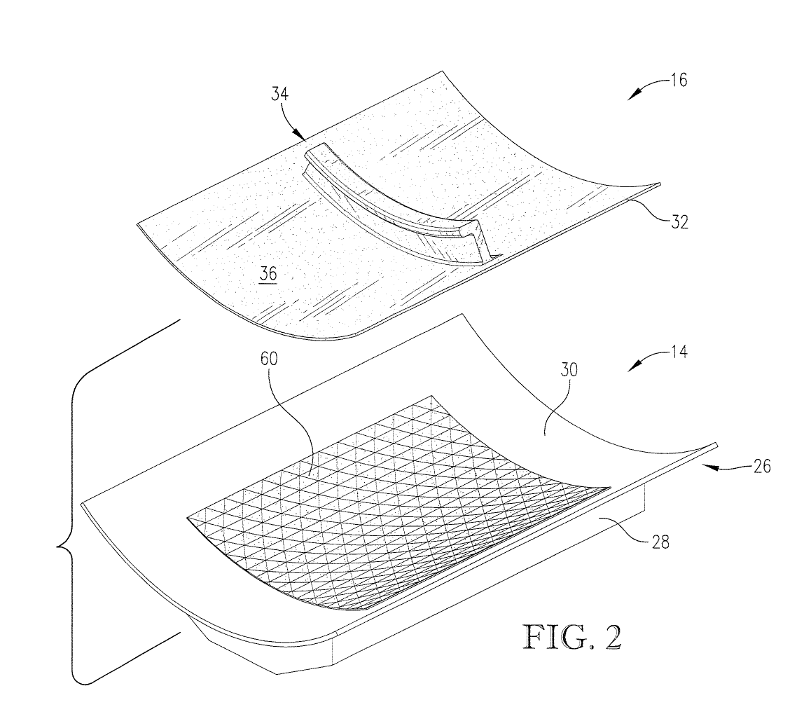

The tool 14, as seen in FIGS. 2 and 4, generally supports a portion of the composite material used to make the composite part 20. The tool 14 may be considered a layup tool or a cure tool. Typically, the tool 14 supports the material that will become an outer mold line (OML) 24 of the composite part 20, which may be defined by an outer surface of the composite part 20. Accordingly, the tool 14 is generally shaped to conform to the shape of a portion of the composite part 20.

An exemplary embodiment of the tool 14 may include a platform 26 and a base 28. The platform 26 may include an upper tool surface 30 upon which the composite material is placed and which has a complementary shape to the shape of the OML 24 of the composite part 20. For example, if the OML 24 is mostly planar, then the upper tool surface 30 is mostly planar. If the OML 24 is curved, then the upper tool surface 30 is similarly curved. The platform 26 rests upon the base 26, which supports the weight of the platform 26, the composite part 20, and the bag 16. The platform 26, including the upper tool surface 30, may be manufactured from material that can withstand a curing process.

The bag 16, as seen in FIGS. 2-4, generally retains a portion of the composite material that is used to form a non-planar feature 22 of the composite part 20. The non-planar feature 22 may include elements or structures that are located outside of the plane of the OML 24, or that may intersect the plane of the OML 24 at an angle up to and including ninety degrees. The bag 16 is generally manufactured from a flexible and resilient material such as rubber or similar materials. In addition, the bag 16 is reusable in that the bag may be used repeatedly to manufacture a plurality of composite parts.

The bag 16 may include a sheet 32 and a chamber 34. The sheet 32 may include an upper sheet surface 36 and a lower sheet surface 38 and may be constructed of flexible material that allows the sheet 32 to adapt to curvatures and contours of the platform 26 of the tool 14, which correspond to curvatures and contours of the part 20. The sheet 32 may be generally smooth and continuous except where the chamber 34 couples to the sheet 32, as described below. In various embodiments, the bag 16 may include a plurality of chambers 34, each of which couple to sheet 32. In other embodiments, the bag 16 include other features, not shown in the figures, that adapt to additional non-planar elements of the composite part 20.

During manufacturing as discussed in more detail below, the sheet 32 generally contacts the upper tool surface 30 and at least a portion of the composite material that may be placed on the upper tool surface 30. The sheet 32 is generally sized to cover a greater surface area than the area of the OML 24 surface of the composite part 20.

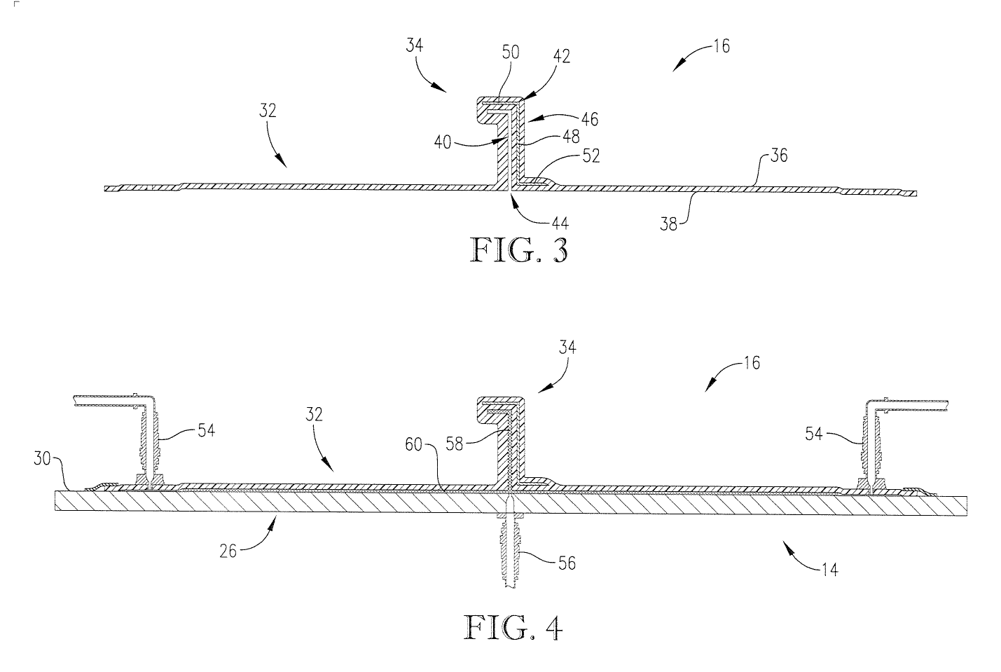

The chamber 34 may couple to the sheet 32 along the upper sheet surface 36 and may be positioned out of the plane of the sheet 32, typically at an angle of up to and including ninety degrees. The chamber 34 may include a cavity 40 and may be positioned adjacent to a support member 42. The cavity 40 generally retains composite material and may be accessed through an opening 44 in the lower sheet surface 38. The shape and dimensions of the cavity 40 typically match the shape and dimensions of the non-planar feature 22 of the composite part 20. The support member 42 generally provides physical support of the chamber 34 to allow the chamber 34 to maintain its shape, which is the shape of the non-planar feature 22. Accordingly, the support member 42 may be manufactured from rigid material in order to provide support. The support member 42 may be positioned adjacent to the cavity 40 and may include a wall 46 for every upper and outer surface of the cavity 40. Thus, if the cross-sectional shape of the cavity 40 (and in turn, the non-planar feature 22) is an inverted “L” shape, then the support member 42 may include a first wall 48 for the vertical outer surface and a second wall 50 for the horizontal upper surface, as seen with the exemplary bag 16 of FIG. 3. In addition, the support member 42 may include a base 52 that is positioned within the sheet 32 to provide cantilever support for the walls 46 of the support member 42. In certain embodiments, the function of the support member 42 may be provided by constructing the chamber 34 and the adjacent area of the sheet 32 from a rigid material that may maintain the proper shape of the non-planar feature 22.

As may be appreciated, the composite part 20 may include more than one non-planar feature 22. Thus, various embodiments of the bag 16 may include a plurality of chambers 34, each with its own cavity 40 and at least one support member 42.

The heating element 18 generally provides a source of high temperature in order to cure the composite material to produce the composite part 20. The heating element 18 may include standard components such as an oven, an autoclave, or the like. Or, in various embodiments, the heating element 18 may include a heat source such as a coil associated with the tool 14 in the vicinity of the platform 26 or the upper tool surface 30.

The system 10 may include additional components such as a vacuum source configured to provide vacuum during the curing process, a source of resin, or other material configured to provide matrix material during the curing process.

The system 10 may operate as follows. Once the final shape of the composite part 20 has been determined, the bag 16 may be created such that the sheet 32 is sized to cover the area of the OML 24. Furthermore, the chamber 34 may be shaped and sized to accommodate the non-planar feature 22 of the composite part 20. In addition, the platform 26 of the tool 14 may be shaped to correspond to the OML 24.

Composite material, in an amount sufficient to form the composite part 20, may be gathered. The composite material may include prepreg reinforcement material or dry reinforcement material. Dry reinforcement may be preformed via thermoforming, stitching, or other methods known in the art. A first portion 58 of the composite material, sufficient to form the OML 24, is placed into the cavity 40 of the chamber 34. The composite material may be placed in the chamber 34 either manually or by using automated machinery and may be placed as closely as possible to the opening 44 of the chamber 34. A second portion 60 of the composite material, sufficient to form the non-planar feature 22, may be placed on the upper tool surface 30 of the platform 26. In various embodiments, a peel ply layer or other barrier material may be applied to the upper tool surface 30 to prevent adherence of the composite material the upper tool surface 30. The order of placement of the first portion 58 and the second portion 60 in their respective areas is not critical. The first portion 58 and the second portion 60 may be placed in any order or simultaneously.

Once the two portions 58, 60 have been placed, then the bag 16 may be positioned on the tool 14 such that the lower sheet surface 38 contacts the upper tool surface 30 and the composite material placed thereon. In addition, the first portion 58 of the composite material may contact the second portion 60. The sheet 32 of the bag 16 may cover the entirety of the second portion 60 of the composite material on the upper tool surface 30. Thus, the first portion 58 and the second portion 60 of the composite material may be fully enclosed by the combination of the bag 16 and the upper tool surface 30. A vacuum may be applied to the system 10 between the bag 16 and the tool 14. The vacuum may be applied through one or more first connectors 54 coupled to the bag 16, as shown in FIG. 4, or through the platform 26 of the tool 14 or possibly both approaches. The vacuum generally pulls the bag 16 against the upper tool surface 30 and holds the composite material in position.

If the composite material includes dry reinforcement material, then a matrix material, such as resin, may be added to complete the composite material mixture. The matrix material may be injected, infused, or otherwise inserted into the system 10 through a second connector 56, as shown in FIG. 4, between the bag 16 and the tool 14 in order to mix or blend with the reinforcement material located on the upper tool surface 30 and within the chamber 34. The matrix material may be infused under the influence of a pressure gradient so as to flow throughout the volume between the bag 16 and the tool 14 and within the cavity 40 of the bag 16. In various embodiments, a resin flow medium may be positioned between the second portion 60 of the composite material and the upper tool surface 30 to assist in the flow of the matrix material across the upper tool surface 30. In addition or as an alternative, matrix material may be infused at other or additional locations of the system 10.

Once the composite material includes the appropriate constituents, either by utilizing prepreg reinforcement material or by infusing matrix material as discussed above, the composite material is cured to harden the matrix material and create the monolithic composite part 20. Curing generally occurs by exposing the composite material, as set up with the bag 16 and the tool 14, to high temperature with the heating element 18. If the heating element 18 includes an oven or an autoclave capable of enclosing the tool 14 and the bag 16, then the tool 14 and the bag 16 are placed in the heating element 18. In other embodiments, if the tool 14 includes the heating element 18, then the temperature of the heating element 18 is raised. Curing takes place at a temperature and for a duration as determined by the composite material. When curing is complete, the temperature is lowered and the vacuum is released. The bag 16 is removed from the tool 14 and the chamber 34 is removed from the non-planar feature 22. At this point, the first portion 58 of the composite material is cocured with the second portion 60. The resulting composite part 20 is a monolithic structure that is ready to be used with no further processing of the part 20 required.

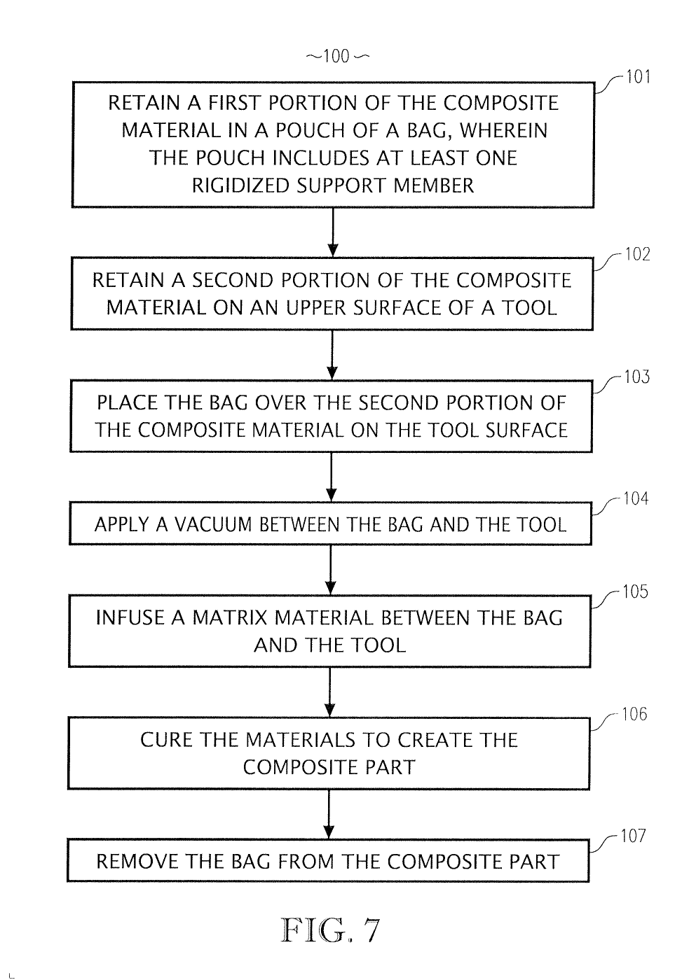

At least a portion of the steps of a method 100 for manufacturing a composite part from a composite material using the system 10 in accordance with various embodiments of the present invention is listed in FIG. 7. The steps may be performed in the order as shown in FIG. 7, or they may be performed in a different order. Furthermore, some steps may be performed concurrently as opposed to sequentially. In addition, some steps may be omitted.

In connection with step 101, a first portion 58 of the composite material is placed in a chamber 34 of a bag 16. The first portion 58 generally forms a non-planar feature 22 of the composite part 20. The bag 16 may include a continuous sheet 32 that is flexible and resilient. The chamber 34 may be adjacent to a cavity 40 to retain the first portion 58 that is supported by a rigid support member 42, which holds the chamber 34 in the shape of the non-planar feature 22.

In connection with step 102, a second portion 60 of the composite material is placed on an upper surface 30 of a tool 14. The second portion 60 generally forms an OML 24 of the composite part 20. The upper tool surface 30 may be formed to match the shape of the OML 24 and may include features such as curvatures or contours.

In connection with step 103, the bag 16 is placed over the second portion 60 of the composite material on the tool surface 30. The sheet 32 of the bag 16 may be sized to cover a surface area that is greater than the area which the second portion 60 occupies on the upper tool surface 30. Once the bag 16 is placed on the tool 14, a lower sheet surface 38 may contact the upper tool surface 30 and the second portion 60 of composite material, and the composite material may be fully enclosed by the combination of the bag 16 and the upper surface 30 of the tool 14.

In connection with step 104, a vacuum may be applied between the bag 16 and the tool 14. The vacuum generally pulls the bag 16 against the upper tool surface 30 and holds the composite material in position.

In connection with step 105, a matrix material is infused between the bag 16 and the tool 14. If the composite material includes dry reinforcement material, then the matrix material is added to give the composite material the proper constituent mixture. This step may be skipped if the composite material includes only prepreg reinforcement material.

In connection with step 106, the composite material is cured to create the composite part 20. The curing is generally accomplished by exposing the composite material to a high temperature from a heating element 18. And the first portion 58 of the composite material may be cocured with the second portion 60.

In connection with step 107, the bag 16 is removed from the composite part 20. The chamber 34 may be removed from the non-planar feature 22. After the bag 16 is removed, the manufacturing process is complete and the composite part 20 is ready for use.

Although the invention has been described with reference to the embodiments illustrated in the attached drawing figures, it is noted that equivalents may be employed and substitutions made herein without departing from the scope of the invention as recited in the claims. For example, the system 10 may include a plurality of individual bags 16 that are stitched, or otherwise joined, together to form a larger bag 16

Having thus described various embodiments of the invention, what is claimed as new and desired to be protected by Letters Patent includes the following:

1. A system for manufacturing a composite part from composite material, the system comprising:
a bag configured to retain a first portion of the composite material, the bag including a support member configured to reinforce and hold a shape of a portion of the bag, the support member further being rigidized and shaped to correspond to a non-planar feature of the composite part; and
a tool including an upper surface configured to retain a second portion of the composite material and on which the bag is placed such that the composite material is fully enclosed by the combination of the bag and the upper surface of the tool.

2. The system of claim 1, wherein the composite part is the monolithic integration of the first portion and the second portion.

3. The system of claim 1, wherein the bag further includes a chamber positioned adjacent to the support member and in which the first portion of the composite material is placed.

4. The system of claim 1, wherein the bag further includes a sheet to which the support member is coupled, the sheet configured to cover the second portion of composite material.

5. The system of claim 1, wherein the upper surface of the tool is shaped to correspond to an outer mold line of the composite part.

6. (canceled)

7. The system of claim 1, further including a heating element configured to produce a high temperature to cocure the first portion of the composite material with the second portion.

8. A system for manufacturing a composite part from composite material, the system comprising:
a bag configured to retain a first portion of the composite material, the bag including a rigidized support member configured to reinforce and hold a shape of a portion of the bag and shaped to correspond to a non-planar feature of the composite part and a chamber positioned adjacent to the support member and in which the first portion is placed; and
a tool including an upper surface configured to retain a second portion of the composite material and on which the bag is placed such that the composite material is fully enclosed by the combination of the bag and the upper surface of the tool,
wherein the composite part is the monolithic integration of the first portion and the second portion.

9. The system of claim 8, wherein the bag further includes a sheet to which the chamber is coupled, the sheet configured to cover the second portion of composite material.

10. The system of claim 8, wherein the upper surface of the tool is shaped to correspond to an outer mold line of the composite part.

11. (canceled)

12. The system of claim 8, further including a heating element configured to produce a high temperature to cocure the first portion of the composite material with the second portion.

13-20. (canceled)
